(19) United States
(12) Patent Application Publication
(10) Pub. No.: US 2016/0078452 A1
(43) Pub. Date: Mar. 17, 2016

(54) Memorabilia Authenticator Process utilizing geolocation assets from satellite or terrestrial sources on mobile devices such as: handsets, watches, tablets, laptops or desktop computers...

(71) Applicant: Clinton Edward Haslerig, Bolinas, CA (US)

(72) Inventor: Clinton Edward Haslerig, Bolinas, CA (US)

(21) Appl. No.: 14/488,292

(22) Filed: Sep. 17, 2014

(51) Int. Cl. G06Q 30/00; H04B 5/00

(52) U.S. Cl. CPC G06Q 30/0185; H04B 5/0062

(57) ABSTRACT

A process by which memorabilia is authenticated using geolocation assets to verify time and place of signing or marking. The assets of smartphones, computers, watches, tablets are used along with a mobile application to certify when and where the interaction occurs. This data is stored along with unique identifying indicators in a data base. This data base signifies ownership of the item along with authentic corresponding geolocation data. The process allows for transfer of ownership with authenticating information transferred and catalogued. All geolocation information is stored and synchronized with subject of memorabilia's location.

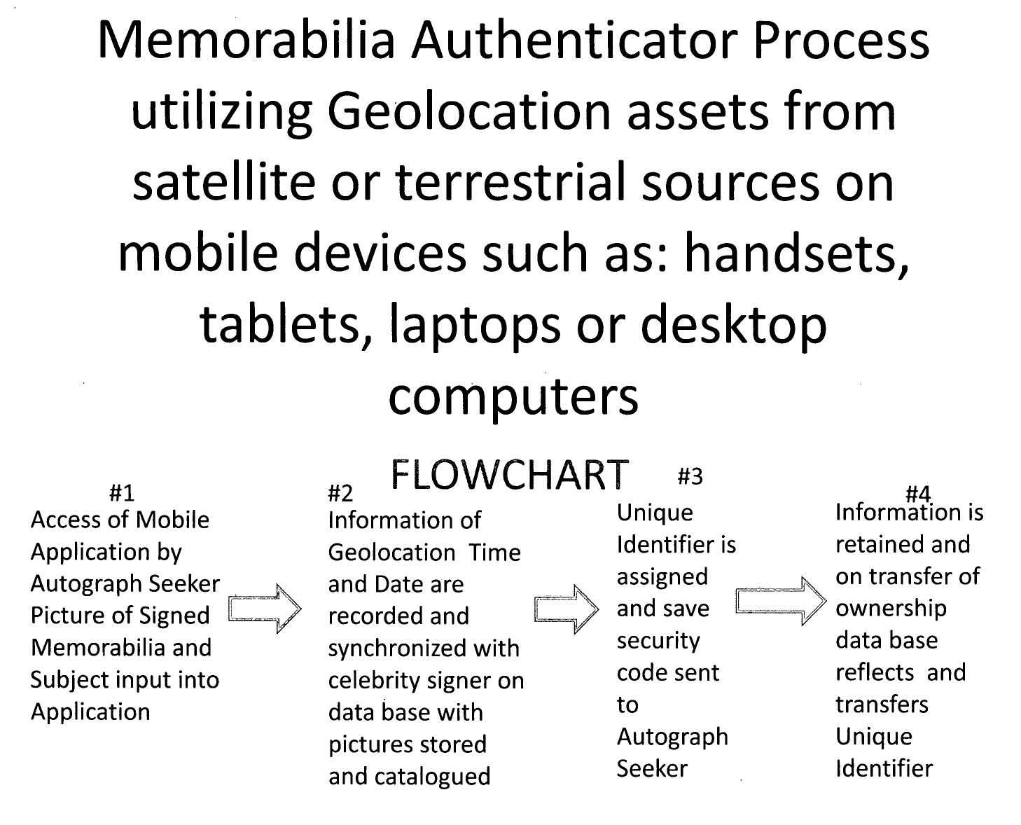

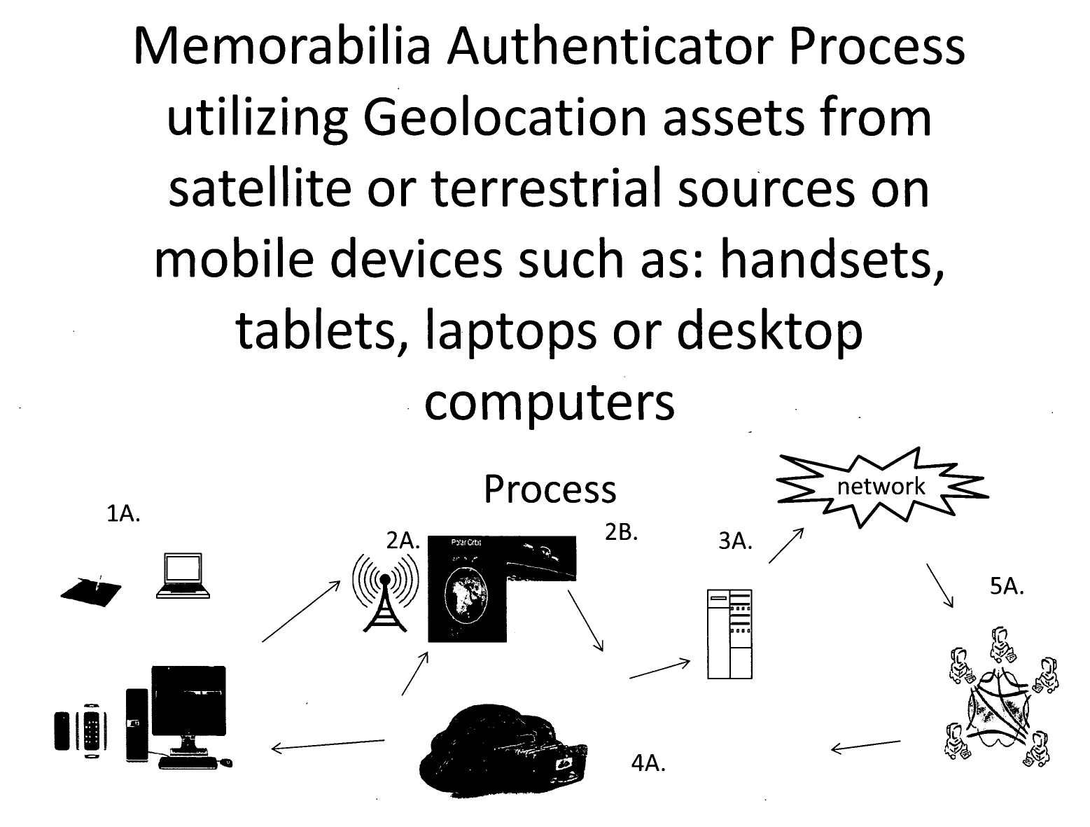

### BACKGROUND

The memorabilia market suffers from 50% of what is offered for sale being fraudulent. Others have offered third party authentication, which is subjective, or use RFID chips to authenticate. Neither of these methods allow for a manner by which provenance is established by the actual subject “celebrity” and refer authentication and collection of data to the originator of the item.

### INVENTION SUMMARY

This process allows memorabilia to be authenticated at the inception of signing by the actual subject personality through geolocation and corresponding app. Being utilized and a unique identifier is assigned and catalogued. Thus tying the object and personality throughout the lifespan of the item. Ownership can be transferred through registration on the app. and this process establishes and maintains provenance of the item.

### INVENTION DESCRIPTION

Through a mobile application, an autograph seeker can document the memorabilia that was signed at the time and place of signing by processing through pictures of the item, celebrity, etc. time, date and geolocation is stamped and synchronized with the geolocation of the celebrity. This process can also be accomplished unilaterally by the celebrity when he or she authenticates an item and sends it to an autograph seeker through correspondence, electronic or missive. In either case a data base is established and unique identifiers are attached to each authentication and stored with owner and grantor noted. All pertinent information such as time and place are contained in the data base as well as pictures of the item. On transfer of ownership, the data base is updated through utilization of the mobile application and the new registered owner is noted and stored retaining a complete history of ownership.

A person would use this system to verify the acquisition of an autographed item, be it memorabilia or simply a celebrity's signature. The item would be geolocation stamped by accessing the mobile application through the persons device and submission of pictures of the item and possibly the subject into the application for processing and acquisition of a unique identifier. These stored and synchronized facts would correlate with the unique identifier, thus verifiable factors increase the value of the item by establishing and maintaining provenance with a direct link to the source of the item.

As an example, a person with a smartphone accesses the mobile application and registers the celebrity they are approaching. They input a picture of the signed item and the subject celebrity. The location, time and date is synchronized with those of the celebrity and a unique identifier is registered and stored in a data base including all of the afore mentioned criteria. The identifier, save a security code is relayed to the autograph seeker. The information is stored for future reference or transfer.

### IMPROVEMENTS ON PRE-EXISTING INVENTIONS

The Memorabilia Authenticator using RFID is a physical innovation that must be attached to an item. Therefore it is limited in its application by physical factors. It also has an added cost aspect for the attendant hardware that must be applied prior to transfer. My process will be available with any item and the choice of utilization of the authentication service is the choice of the memorabilia seeker at the time of acquisition. In addition with the registration of ownership through the unique identifier, there is a deterrent to theft and unauthorized transfer is hindered without the unique identifier.

### OTHER USES OR APPLICATIONS FOR THIS INVENTION

This process could be used for any item or situation whereas synchronization of location and time establishes verification of action. The only limiting factor would be that both parties be pre-prescribed to the proper aspect of the application.

### EXPLANATION OF DRAWINGS

Flow Chart

1. Access by Seeker of application and submission of pictures of item and or Celebrity

2. Geolocation information: time date and place are synchronized with that of Celebrity and stored on data base

3. Unique Identifier is assigned saved and relayed to Seeker, save security code

4. Information is retained and if a transfer of ownership occurs, data base reflects that fact and transfers Unique Identifier save security code

### PROCESS CHART

1A. Handsets (Smartphones), watches, tablets, laptops, desktop computers
2A. Terrestrial sources
   Or
2B. Satellite sources
3A. Storage Network
4A. Application Mobile and Web
5A. Subsequent Transfer of Ownership

1. Whereas the Memorabilia Authentication using RFID is a system which uses specific hardware attached to memorabilia. This invention differs by processing and storing pertinent information and data that creates provenance by processing.
This invention comprising of a process that authenticates memorabilia by utilizing mobile devices; handsets, watches. Tablets, laptops and desktop computers through geolocation on satellite or terrestrial sources using pictures, date, time and positioning data and synchronizes that data within an application that is verifying of time and place of authentication by the originating source of the object of memorabilia, storing, sharing and distributing said information to appropriate stakeholders and retaining security codes for verification when transferring ownership comprising a process to maintain provenance of memorabilia with an initial source of authentication being the celebrity signer.
